(19) United States
(12) Patent Application Publication
(10) Pub. No.: US 2025/0313392 A1
(43) Pub. Date: Oct. 9, 2025

(54) SEALED SINGLE-DOSE PACKAGE FOR LARGE PRODUCT SIZES

(71) Applicant: EASYSNAP TECHNOLOGY S.R.L., Castellazzo Bormida (Alessandria) (IT)

(72) Inventors: Andrea TAGLINI, Castellazzo Bormida (Alessandria) (IT); Tomas DI GIROLAMO, Castellazzo Bormida (Alessandria) (IT)

(21) Appl. No.: 18/864,626

(22) PCT Filed: Jun. 19, 2023
(86) PCT No.: PCT/IB2023/056324

§ 371 Date: Nov. 11, 2024

(30) Foreign Application Priority Data
Jun. 22, 2022 (IT) 102022000013183

(51) Int. Cl. B65D 75/36; B65B 5/02; B65B 5/04; B65B 51/22; B65D 75/58

(52) U.S. Cl. CPC B65D 75/366; B65B 5/02; B65B 5/04; B65B 51/22; B65D 75/585

(57) ABSTRACT

A sealed single-dose package having a multi-layer semi-rigid sheet, a flexible sheet superimposed and welded to the multi-layer semi-rigid sheet to form an inner pocket for containing one dose of a product is provided. An outer incision in the multi-layer semi-rigid sheet is adapted to guide, upon bending of the sealed single-dose package, a breakage of the multi-layer semi-rigid sheet to form an opening for the product contained in the pocket to escape. The inner pocket has a narrow portion aligned with the outer incision. The sealed single-dose package ensures proper opening especially for large product sizes.

The present invention relates to the field of packaging and in particular to the field of sealed single-dose packages with a break opening of the “one hand opening” type, i.e. which may be opened by bending the package with one hand.

These packages, by virtue of the indisputable practicality of use thereof, have become considerably widespread; currently, several hundreds of millions of packages of this type are marketed every year in many industries, for example for food products, such as sauces and other condiments, and pharmaceutical products, such as eye drops and dermatological creams.

For packages intended for large sizes, it has been noted that when there is a large amount of product present, they offer resistance when bending, making it difficult to open the package.

The object of the present invention is to make a package that ensures proper opening especially for large sizes, so that even with large quantities of product, bending for opening is easy.

Given the widespread use of such packages and a profound change in the attitudes of consumers towards the issues of sustainability and environmental protection, the problem of the correct disposal of used packages is now particularly felt. Such packages are substantially made from film consisting of a plastics material, and therefore the consumer is now particularly careful when it comes to the purchasing thereof. Furthermore, after use, it is necessary that they be recycled.

It is also the object of the present invention to make a package that ensures proper opening for large sizes and that is predominantly paper-, cardboard-, or cellulose-based.

The object of the present invention is to provide a sealed single-dose package with break opening which meets the needs of the field and at the same time overcomes the aforementioned drawbacks.

Such an object is achieved by a sealed single-dose package with a break opening according to claim 1. The dependent claims disclose further advantageous embodiments of the invention.

The features and advantages of the package according to the present invention will appear more clearly from the following description, given by way of non-limiting example with to reference the drawings of the accompanying figures, in which:

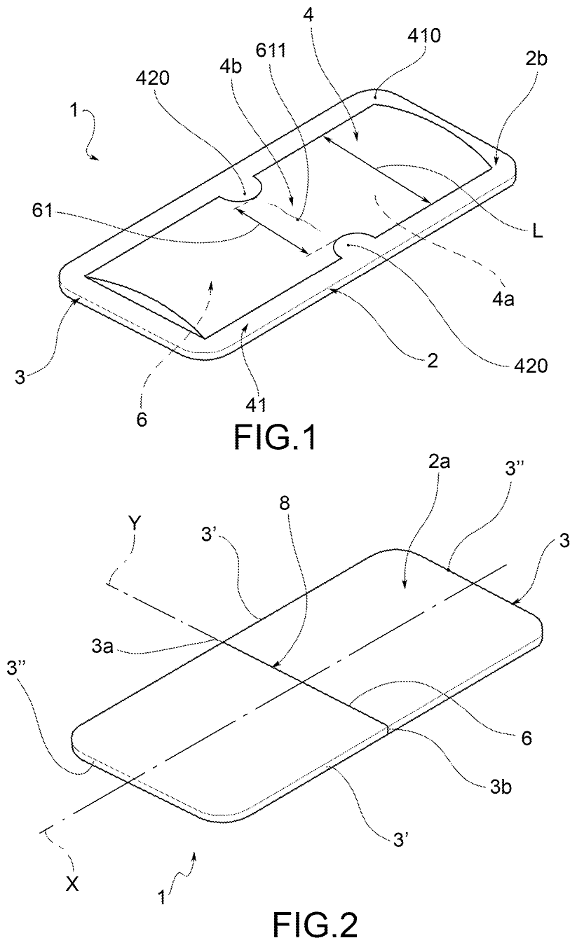

FIG. 1 shows a sealed single-dose package according to an embodiment of the present invention, shown from the front;

FIG. 2 shows the rear face of a semi-rigid sheet of the package, according to one embodiment of the invention;

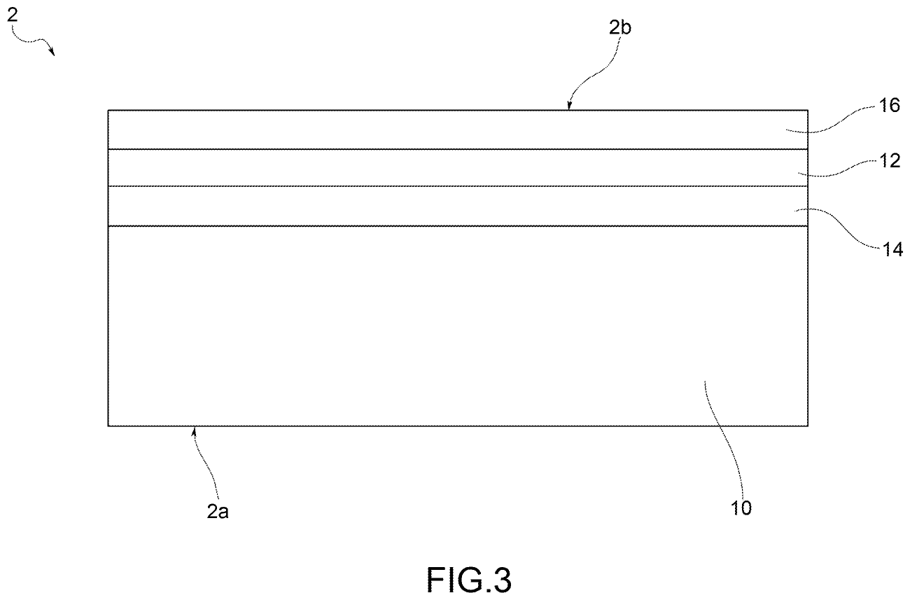

FIG. 3 shows an example diagram of the multi-layer structure of a semi-rigid sheet of the package according to one embodiment of the invention;

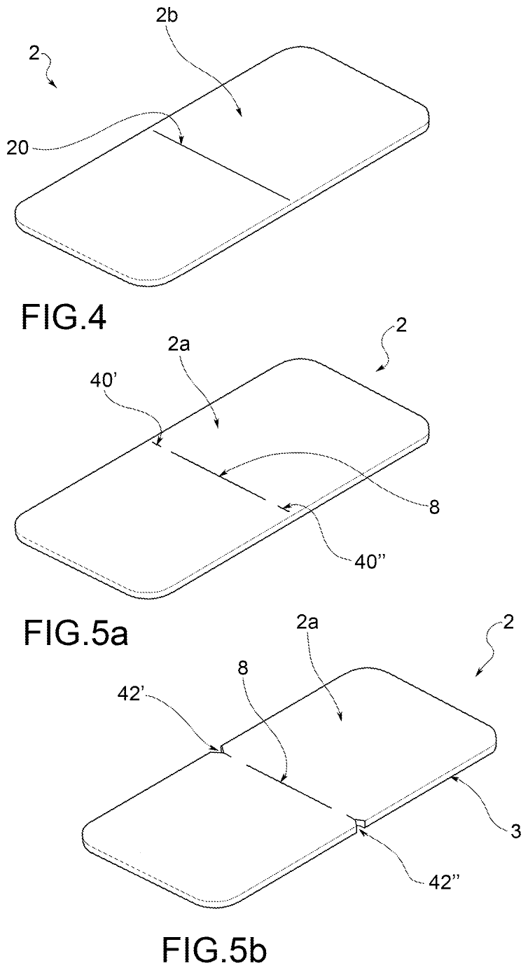

FIG. 4 shows the front face of a semi-rigid sheet of the package, according to one embodiment of the invention;

FIGS. 5a and 5b show further embodiments of the rear face of the semi-rigid sheet of the package;

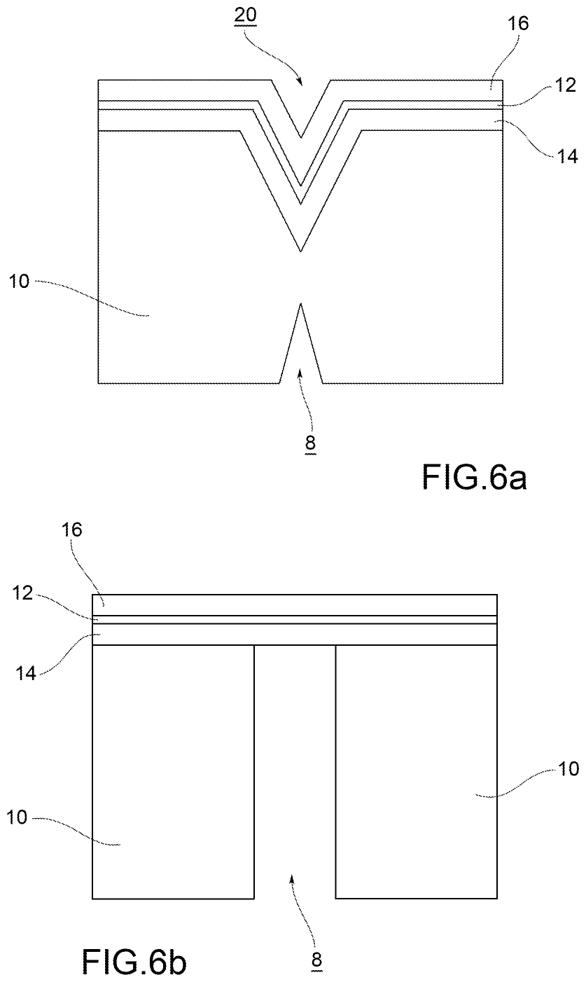

FIGS. 6a and 6b show some embodiments of the semi-rigid sheet of the package;

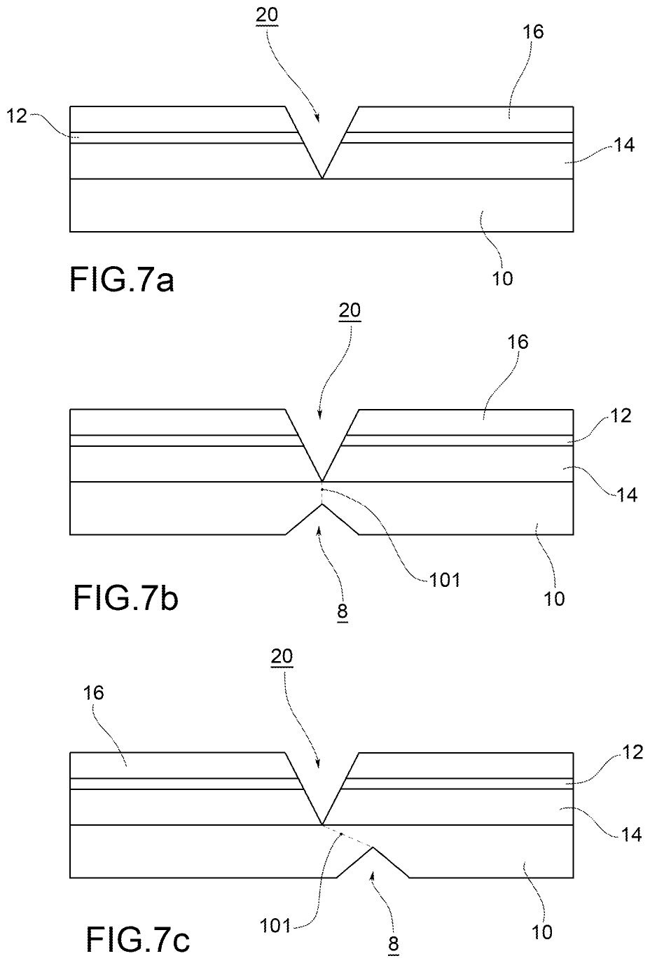

FIGS. 7a to 7c show further embodiments of the semi-rigid sheet of the package;

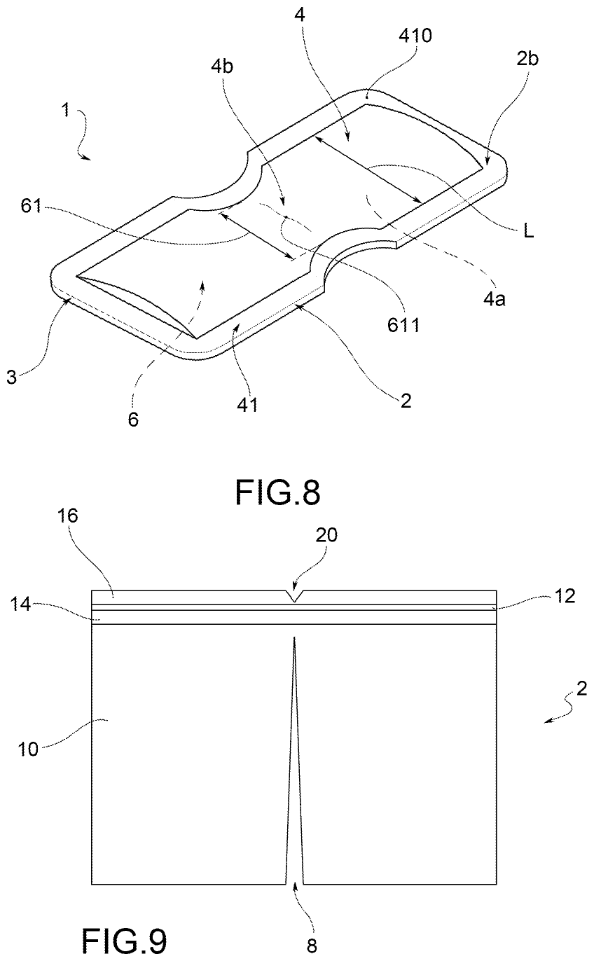

FIG. 8 shows a sealed single-dose package according to a further embodiment of the present invention, shown from the front;

FIG. 9 shows another embodiment of the semi-rigid sheet of the package, in the case of a carrier layer made of paper, cardboard or other predominantly cellulose-based material;

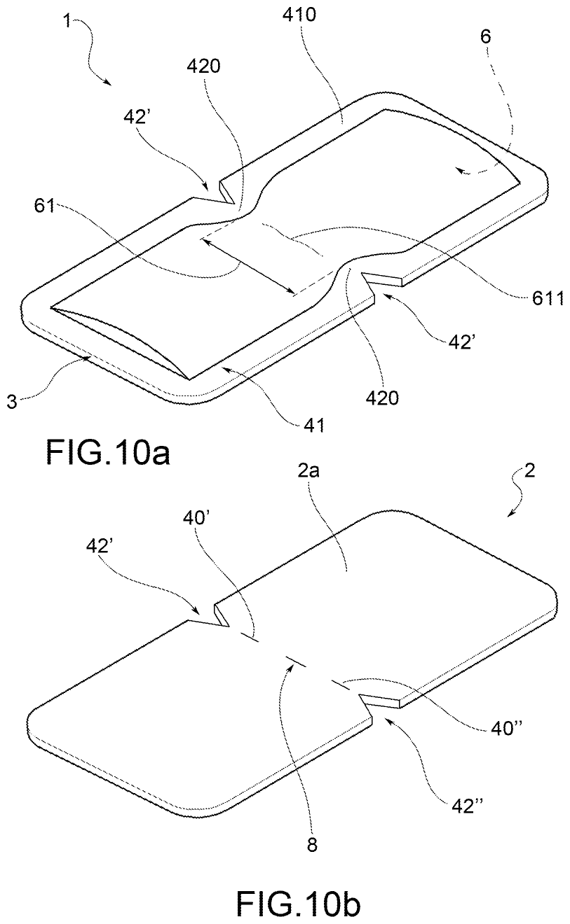

FIGS. 10a and 10b show the front and back sides of a single-dose sealed package, respectively, according to yet another embodiment of the present invention.

With reference to the figures of the accompanying tables, reference numeral 1 denotes a sealed single-dose package with a break opening.

The package 1 comprises a semi-rigid sheet 2, delimited by a peripheral edge 3 and having a rear face 2a and an opposite front face 2b, and a flexible sheet 4, having an inner face 4a and an outer face 4b. The flexible sheet 4 is superimposed on the semi-rigid sheet 2, so that the inner face 4a faces the front face 2b, and welded thereto, so as to form an inner pocket 6 for containing one dose of a product.

Advantageously, the single-dose sealed package 1 according to the present invention has a pocket 6 equipped with a narrow portion 61, centrally arranged and aligned with the outer incision 8 of the semi-rigid sheet 2. Preferably, the narrow portion 61 has a width between 20% and 95% of the maximum width L of the pocket 6. The pocket 6 thus has a substantially hourglass shape, as seen in FIGS. 1 and 8.

In the example embodiment in FIG. 1, the package 1 has a rectangular shape, and the pocket 6 has an hourglass shape, obtained through a pair of protruding welds 420 as described below.

In the example embodiment in FIG. 8, both the package 1 and the pocket 6 have hourglass shapes, achieved by a peripheral weld 410. As may be noted, the semi-rigid sheet 2 has a pair of weakened portions consisting of recesses obtained along a peripheral edge 3, arranged centrally with respect to the package 1. In 5 this example, the recesses are in the shape of a semicircle.

In the example embodiment in FIG. 10a, both the package 1 and the pocket 6 have hourglass shapes. As may be noted, the semi-rigid sheet 2 has a pair of weakened portions comprised of recesses made along a peripheral edge 3. As may be seen, two recesses 42′, 42″ are provided, aligned with the outer incision 8 and arranged centrally with respect to the package 1. In this example, the recesses are triangular, with the tip facing and 15 aligned with the outer incision 8, as shown in FIG. 10b. The pocket 6 has an hourglass shape, obtained through a pair of protruding welds 420, as seen in FIG. 10a. The protruding welds 420 are arranged between the recesses 42′, 42″ and the narrow portion 61.

The presence of the narrow portion 61, and thus the substantially hourglass shape of the pocket 6, allows for a kind of division of the product content in said pocket 6 to be obtained. Thus, when the package 1 is folded to obtain the opening, the contents of the pocket 6 are already substantially divided into two parts and do not hinder, by its presence at the outer incision 8, the bending of the package. This solution is particularly advantageous for large sizes, wherein the package contains a large amount of product, which with its volume could make bending for opening difficult. Too large a narrow portion would have no effect on the bending of the package 1. Preferably, the narrow portion 61 has a maximum width of less than 95% of the maximum width L of the pocket 6. Conversely, a narrow portion that is too narrow would eventually hinder the flow of the product, which would be trapped without being able to escape properly during dispensing. Preferably, the narrow portion 61 has a minimum width greater than 20% of the maximum width L of the pocket 6.

Advantageously, moreover, the narrow portion 61 is aligned with the outer incision 8 of the semi-rigid sheet 2 to facilitate the opening of the package when bending the package itself.

Preferably, the narrow portion 61 is arranged centrally to the pocket 6, which takes on an hourglass shape, as in FIGS. 1 and 8.

Preferably, the flexible sheet 4 has a crease 611, i.e. a fold, at the narrow portion 61.

Preferably, the semi-rigid sheet 2 has a pair of weakened portions, arranged so as to face each other, at the narrow portion 61 of the pocket 6 and aligned with the outer incision 8. For example, each weakened portion consists of a recess obtained along a peripheral edge 3 of the semi-rigid sheet 2, and wherein said weakened portions are arranged centrally with respect to the package, which takes an hourglass shape, as in FIG. 8 and FIG. 10a, arranged centrally with respect to the package 1. The recesses have, for example, a semicircular or triangular shape with a tip facing and aligned with the outer incision 8.

The flexible sheet 4 is welded to the semi-rigid sheet 2 by a weld 41 that extends around the peripheral edge 3. The weld 41 forms the outline of the pocket 6. The weld 41 comprises a peripheral portion 410 that

completely follows the peripheral edge 3, preferably continuously, without interruption, and preferably always with the same thickness. This example is shown in FIGS. 1 and 8.

Preferably, as in the example in FIGS. 1 and 10a, the weld 41 comprises at least one protruding portion 420 which extends toward the pocket 6, beyond the contour of the peripheral weld 410. Preferably, the weld 41 comprises two protruding portions 420, arranged opposite each other, as shown in FIG. 1. The protruding portions 420 of the weld form the narrow portion 61 of the pocket 6.

The protruding portion 420 is aligned with an outer incision 8 made in the semi-rigid sheet 2 and better described hereinafter. Preferably, the weld 41 comprises two protruding portions 420 arranged on both sides of the outer incision 8.

Preferably, the protruding portion 420 is arranged substantially in the central portion of the long side 3′ of the semi-rigid sheet 2.

The protruding portion 420 may have different shapes, such as semicircular as in FIG. 1, or oval, or triangular as in FIG. 10a, or rectangular, or other polygonal or non-polygonal shape. The protruding portion 420 preferably has a

substantially semicircular shape, or at least curved and convex, to prevent some of the product from being trapped and not escaping properly during dispensing.

The presence of the protruding portion 420 of the weld 41 results in the formation of a narrow portion 61 in the pocket 6. In the case of two protruding portions 420 facing each other, the pocket 6 takes on a substantially hourglass contour, with a central narrow portion 61.

Preferably, the narrow portion 61 of the pocket 6 is obtained in the following way:
making a part of the peripheral portion 410 of the weld 41 to partially join the flexible sheet 4 and the semi-rigid sheet 2 so as to partially form the pocket 6, thus making a cavity capable of containing the product, but still open and accessible from the outside;
inserting a predetermined amount of product into the pocket 6;
completing the peripheral portion 410 of the weld 41 to join the flexible sheet 4 and the semi-rigid sheet 2 to fully form the pocket 6, thus making a sealed cavity, filled with product, and not accessible from the outside;
completing the weld 41 by making at least one protruding portion 420, preferably a pair of protruding portions 420.

The solution of forming the protruding portions 420 of the weld when the pocket 6 is already filled with product provides a double benefit. First, it avoids reducing the capacity of the pocket 6 and thus of the container; it also allows the product inside the pocket 6 to be compressed, so that said product increases the stiffness of the container and promotes bending in the center.

The solution of making the protruding portions 420 of the weld when the pocket 6 is already filled with product allows for a crease 611, i.e., a fold, to be obtained in the flexible sheet 4 that further facilitates the bending of the package 1 when opening. The presence of the crease 611 in the flexible sheet 4 allows for the division of the product content in said pocket 6 to be accentuated. This solution is particularly advantageous for large sizes, wherein the package contains a large amount of product, which with its volume could make bending for opening difficult.

Preferably, the crease 611 is a straight, continuous fold in the flexible sheet 4.

Preferably, the crease 611 in the flexible sheet 4 is aligned with the outer incision 8.

Preferably, the crease 611 in the flexible sheet 4 is arranged between the two protruding portions 420.

Preferably, the crease 611 in the flexible sheet 4 is arranged centrally to the narrow portion 61.

The package according to the present invention is particularly suitable for holding large quantities of product, such as 10 ml to 25 ml of product. For example, 12 ml of product in an 80 mm×60 mm size, or 18 ml of product in a 100 mm×60 mm size, or 20 ml of product in a 100 mm×66 mm size, or 25 ml of product in a 100 mm×80 mm size.

According to an example embodiment, the semi-rigid sheet 2 has a rectangular shape and has opposite long sides 3′ and opposite short sides 3″; the semi-rigid sheet 2 extends along a longitudinal axis X parallel to the long sides 3′.

The semi-rigid sheet 2, which, for example, has a thickness of between 300-750 microns overall, is a multi-layer laminate comprising a carrier layer 10 having said rear face 2a. The carrier layer 10, which is mono-layer or multi-layer, is made of plastics, or paper, cardboard or another predominantly cellulose-based material (i.e. cellulose-based for at least 50% by weight). The carrier layer 10 has, for example, a thickness of between 250-700 microns.

Preferably, internally, the semi-rigid sheet 2 comprises a barrier layer 12 suited for providing a barrier against the passage of gas, and in particular against the passage of oxygen, or vapor, or gas and vapor.

For example, the barrier layer 12 is mono-layer or multi-layer, in aluminum or EVOH (ethylene vinyl alcohol), or combinations thereof. In those variants wherein the barrier layer is multi-layer, some films may be made from non-barrier materials.

Alternatively, the carrier layer 10 has a film coated onto the face opposite the front face 2a, wherein said coated film has barrier properties.

Alternatively, the carrier layer 10 is subjected to chemical treatment so as to cause it to assume barrier properties, at least upon the face opposite to the rear face 2a. Alternatively, a metallized film, for example metallized PET or metallized PE, is glued to the carrier layer 10, wherein the metallization faces towards the paper.

On the opposite side of the rear face 2a, and preferably between the carrier layer 10 and the barrier layer 12, the semi-rigid sheet 2 also comprises at least one intermediate layer 14, which is mono-layer or multi-layer, comprising an adhesive or an extruded polymer, for example polyethylene or polypropylene, or another material that binds with the carrier layer 10.

Furthermore, the semi-rigid sheet 2 comprises a final layer 16 having said front face 2b. The final layer 16, which is mono-layer or multi-layer, comprises polyethylene or polypropylene or a solder varnish or another material that is suitable for being welded to the flexible film 4.

The flexible sheet 4 is a multi-layer laminate comprising an inner layer having said inner face 4a. The inner layer, which is mono-layer or multi-layer, comprises polyethylene or polypropylene or a solder varnish or another material suitable for being welded to the semi-rigid film 2.

Externally, the flexible sheet 4 comprises an outer layer having said outer face 4b. The outer layer 32, which is mono-layer or multi-layer, comprises paper, cardboard or another material predominantly cellulose-based.

Furthermore, the flexible sheet 4 preferably comprises an intermediate layer arranged between the inner layer and the outer layer. For example, the intermediate layer, which is mono-layer or multi-layer, has barrier properties and comprises aluminum or EVOH, and/or has binding properties with the inner layer 30 and with the outer layer 32. Alternatively, the outer layer has a film coated upon the face opposite the outer face 4b, wherein said coated film has barrier properties. Or, a metallized film is glued on the outer layer, such as metallized PET or metallized PE, wherein the metallization is facing the paper.

According to an embodiment variant, the flexible sheet 4 has no intermediate layer and the inner layer is directly in contact with the outer layer.

In a preferred example embodiment, the package 1 is predominantly paper, cardboard, or other predominantly cellulose-based material. In this example, overall, the paper, cardboard or other predominantly cellulose-based material of the semi-rigid sheet and the paper, cardboard or other predominantly cellulose-based material of the flexible sheet together constitute at least 60% by weight of the entire (empty) package.

As shown in FIG. 2, the rear face 2a of the semi-rigid sheet 2, at the pocket 6, has an outer incision 8 extending along an incision direction Y, which is for example transversal, i.e., in the aforesaid embodiment, it extends along a direction incident to the longitudinal axis X, preferably orthogonal thereto. The outer incision 8 is adapted to guide, upon a bending of the package 1, a controlled breakage of the semi-rigid sheet 2 along said incision so as to cause the formation, through said semi-rigid sheet, of an opening for the product contained in the pocket 6 to escape.

For example, as in FIG. 2, the outer incision 8 joins two opposite points 3a, 3b of the peripheral edge 3; in the aforesaid embodiment, this means that it extends over the entire width of the rectangular semi-rigid sheet.

According to a further embodiment variant, as in FIG. 4, the outer incision 8 is interrupted before the peripheral edge 3, or it starts from a point on the peripheral edge 3 and is interrupted before reaching the other point of the peripheral edge 3.

The outer incision 8 partially cuts across the carrier layer 10 of the semi-rigid sheet 2.

Said incision has a depth H with respect to the front face 2a that is typically variable transversely along the outer incision 8. For example, the depth is greatest in a central segment of the incision. Advantageously, this variation in depth along the incision ensures the break opening in a controlled manner, preventing the break from being sudden and therefore preventing the product from being projected outwards in a damaging manner.

In one example embodiment, the outer incision 8 has a constant cross-section as the depth varies, as in the example of FIG. 6b, wherein it has a rectangular or square cross-section.

In one example embodiment, the outer incision 8 has a tapered cross-section, as in the example of FIG. 6a, wherein it has a triangular cross-section with the tip towards the carrier layer 10.

As shown in FIG. 4, on the front face 2b of the semi-rigid sheet 2, i.e., the face that at least partially defines the inner pocket 6 in which the product is contained, there is an inner incision 20 that extends along an incision direction Y, which is, for example, transversal, i.e., in the above embodiment, along a direction incident to the longitudinal axis X, preferably orthogonal thereto.

In the embodiment of FIG. 6a, the inner incision 20 does not cut across the barrier layer 12, which remains intact. In this embodiment, the inner incision 20 is a more or less sharp depression, without material breakage, due to permanent compression of the material.

In the embodiment of FIG. 9, the inner incision 20 does not cut across the barrier layer 12, which remains intact. In this embodiment, the inner incision 20 is a true incision, cutting into the material.

In the embodiments of FIGS. 7a to 7c, the inner incision 20 cuts across the barrier layer 12 that is interrupted by an extremely small micro-hole. Preferably, the micro-hole 201 makes an opening in all of the layers of the semi-rigid sheet 2, with the exception of the paper layer. Preferably, the micro-hole 201 at least partially follows the geometry of the inner incision 20. The micro-hole 201 serves to trigger the breaking of the barrier layer 12, and to promote the breaking of any further elastic layers (the intermediate layer 14 and final layer 16 where present) of the rigid sheet 2, during the bending of the package. In fact, unlike the paper carrier layer 10, the barrier layer 12 is elastic and tends to elongate rather than break, so as to prevent in some cases the correct opening of the package. The micro-hole 201, therefore, ensures the propagation of the cracking on the barrier layer 12 during the bending of the package, which then opens correctly. Preferably, the micro-hole 201 is separated from the outer environment by the interposition of a portion of the paper carrier layer 10, referred to as the barrier portion 101. Preferably, the barrier portion 101 of the paper carrier layer 10 has a minimum thickness of 10 microns. It should be noted that the paper that makes up the carrier layer 10 does not have barrier properties to the passage of gas and/or vapor, or in any case not significant properties. The extremely small size of the micro-hole 201 does however mean that the surface of the carrier layer 10, which in effect remains without a barrier layer 12, is so small that it is irrelevant to the shelf life of the product. This example embodiment is particularly suitable for dense fluid products, insofar as they are not absorbed by the paper, cardboard or cellulose barrier layer 10.

In an example embodiment, the inner incision 20 has a constant cross-section as the depth changes, and for example has a rectangular or square cross-section.

In one embodiment, the inner incision 20 has a tapered cross-section, as in the examples of FIGS. 7a to 7c, wherein it has a triangular cross-section with the tip toward the carrier layer 10.

According to an embodiment shown in FIGS. 6a and 7b and 9, the inner incision 20 is aligned, i.e. completely superimposed, with the outer incision 8.

Preferably, in the case of a carrier layer 10 made of paper, cardboard, or other predominantly cellulose-based material, the outer incision 8 is very deep, almost to the barrier layer 12.

According to an embodiment shown in FIG. 7c, the inner incision 20 is misaligned, i.e. not completely superimposed, with the outer incision 8.

According to a further embodiment variant (FIGS. 5a and 5b and 10b), the semi-rigid sheet 2, in order to facilitate the bending of the package, has at least one weakened portion that is separate from and preferably aligned with the outer incision 8. Preferably, the weakened portions are arranged at the protruding portions 420 of the weld 41. Preferably, the weakened portions are aligned with the inner incision 20.

Preferably, the rear face 2a of the semi-rigid sheet 2 has at least one weakened portion.

Preferably, in the case of weakened portions, these are made at a protruding portion 420 of the weld 41.

For example, as in FIGS. 5a and 10b, the rear face 2a has two weakened portions 40′, 40″ aligned with the outer incision 8, arranged on either side of central outer incision 8. In this example, the outer incision 8 is interrupted before the peripheral edge 3. Said weakened portions have a depth less than or equal to that of the outer incision 8.

Preferably, each weakened portion consists of at least one incision (FIG. 5a). According to one embodiment variant, each weakened portion consists of a plurality of holes.

Alternatively (FIG. 5b), each weakened portion consists of a recess obtained along the peripheral edge 3 of the semi-rigid sheet 2. For example, two recesses 42′, 42″ are provided, aligned with the inner incision 8. In this example, the outer incision 8 is interrupted before the peripheral edge 3.

In the example in FIG. 10b, the package has both two weakened portions 40′, 40″, aligned with the outer incision 8, and two recesses 42′, 42″, aligned with the outer incision 8. Said weakened portions 40′, 40″ may have a depth less than or equal to that of the outer incision 8. Said recesses 42′, 42″ preferably have a triangular shape with the tip aligned with the outer incision 8. Preferably, the weakened portions 40′, 40″ and the recesses 42′, 42″ are aligned with the inner incision 20.

Further embodiments of the invention are now described.

According to one embodiment, the inner incision 20 of the carrier layer has a constant depth.

According to one embodiment, the outer incision 8 of the carrier layer has a constant depth.

According to an embodiment variant of the package according to the invention, the semi-rigid sheet 10 has a circular or oval shape or a regular or mixed polygonal shape, i.e., consisting of rectilinear sections and arched sections.

Innovatively, the package according to the present invention simultaneously ensures proper opening especially for large sizes, wherein the package contains a large amount of product that could make bending for opening difficult.

Advantageously, in fact, the solution of making an essentially hourglass-shaped pocket, i.e., equipped with a narrow portion, facilitates the bending of the package when opening as it forms a kind of division of the product content in the pocket. It is clear that a person skilled in the art, in

order to satisfy contingent needs, could make modifications to the package described above, said modifications all being contained within the scope of protection defined in the following claims.

1. A sealed single-dose package with a break opening, comprising:
a multi-layer semi-rigid sheet comprising a rear face and an opposite front face, and a carrier layer having said rear face, said carrier layer being made of paper, cardboard or other predominantly cellulose-based material;
a flexible sheet comprising an inner face and an outer face, superimposed on the multi-layer semi-rigid sheet so that the inner face faces the front face, and welded to the front face of the multi-layer semi-rigid sheet so as to form an inner pocket for containing one dose of a product;
an outer incision extending along an incision direction, made in the rear face of the multi-layer semi-rigid sheet, adapted to guide, upon a bending of the sealed single-dose package, a breakage of the multi-layer semi-rigid sheet to form an opening for the product contained in the inner pocket to escape; and
an inner incision extending along the incision direction, made in the front face of the multi-layer semi-rigid sheet;
wherein the inner pocket has a narrow portion aligned with said outer incision.

2. The sealed single-dose package of claim 1, wherein the inner incision is aligned, superimposed, with the outer incision.

3. The sealed single-dose package of claim 1, wherein the flexible sheet comprises a crease, i.e., namely a fold, at the narrow portion.

4. The sealed single-dose package of claim 1, wherein the multi-layer semi-rigid sheet comprises a pair of weakened portions at the narrow portion of the inner pocket, aligned with the outer incision, on both sides of the outer incision.

5. The sealed single-dose package of claim 4, wherein each weakened portion consists of at least one incision.

6. The sealed single-dose package of claim 4, wherein each weakened portion consists of a recess along a peripheral edge of the multi-layer semi-rigid sheet, and wherein said weakened portions are arranged centrally with respect to the sealed single-dose package, which takes an hourglass shape.

7. The sealed single-dose package of claim 4, wherein the multi-layer semi-rigid sheet comprises a pair of weakened portions in a form of recesses followed by a pair of weakened portions in a form of incisions, both the incisions and the recesses being aligned with the outer incision, on both sides of the outer incision.

8. The sealed single-dose package of claim 6, wherein said recesses are triangular in shape with a tip pointing toward the outer incision.

9. The sealed single-dose package of claim 1, wherein the flexible sheet is welded to the multi-layer semi-rigid sheet by a weld comprising a peripheral portion which follows a peripheral edge of the multi-layer semi-rigid sheet and a pair of protruding portions, and wherein said protruding portions are arranged facing each other, are aligned with said outer incision made in the multi-layer semi-rigid sheet, and extend towards the inner pocket which takes an hourglass shape.

10. The sealed single-dose package of claim 9, wherein the multi-layer semi-rigid sheet comprises a pair of weakened portions at the narrow portion of the inner pocket, aligned with the outer incision, on both sides of the outer incision, and wherein said weakened portions are made at the protruding portions of the weld.

11. The sealed single-dose package of claim 1, wherein the multi-layer semi-rigid sheet comprises a barrier layer suited for forming a barrier to passage of gas and/or vapor.

12. The sealed single-dose package of claim 11, wherein the barrier layer has a micro-hole separated from an external environment by an interposition of a portion of the carrier layer.

13. The sealed single-dose package of claim 1, wherein said flexible sheet comprises an outer layer having said outer face, and wherein said outer layer, which is single-layer or multi-layer, comprises paper, cardboard or other predominantly cellulose-based material.

14. The sealed single-dose package of claim 1, wherein the inner pocket has a maximum width, and the narrow portion has a width between 20% and 95% of the maximum width.

15. A method for making a sealed single-dose package according to claim 1, the method comprising:
providing a rectangular multi-layer semi-rigid sheet delimited by a peripheral edge and comprising a rear face and an opposite front face, an outer incision being made on the rear face;
providing a flexible sheet comprising an inner face and an outer face;
superimposing the flexible sheet on the multi-layer semi-rigid sheet so that the inner face faces the front face;
welding the flexible sheet to the multi-layer semi-rigid sheet by a weld obtained by:
at least partially making a peripheral portion of the weld to partially join the flexible sheet and the multi-layer semi-rigid sheet to partially form an inner pocket;
inserting a predetermined amount of product into the inner pocket;
completing the peripheral portion of the weld to completely close the inner pocket; and
completing the weld by making at least one protruding portion towards the inner pocket.
